(19) United States
(12) Patent Application Publication
(10) Pub. No.: US 2003/0200877 A1
(43) Pub. Date: Oct. 30, 2003

(54) Press having a feeding device

(75) Inventor: Klaus Blei, Wangen (DE)

Correspondence Address: CROWELL & MORING LLP, INTELLECTUAL PROPERTY GROUP, P.O. BOX 14300, WASHINGTON, DC, 20044-4300, US

(73) Assignee: Schuler Pressen GmbH & Co. KG

(21) Appl. No.: 10/422,763

(22) Filed: Apr. 25, 2003

(30) Foreign Application Priority Data
Apr. 26, 2002 (DE) 102 18 716.9

(51) Int. Cl. B30B 1/00; B30B 1/42

(52) U.S. Cl. 100/214

(57) ABSTRACT

A press has a feeding device for feeding material to be machined. The feeding device has at least two motor-driven feeding rollers between which the material to be fed is guided through. The motor drive of the feeding rollers is housed in the feeding rollers. At least one of the feeding rollers can be lifted off the material to be fed and can be placed back onto the material to be fed. The feeding device is arranged on the press such that the feeding device has a degree of freedom in the vertical direction relative to the press.

### BACKGROUND OF THE INVENTION

This application claims the priority of Germany, filed Apr. 26, 2002, the disclosure(s) of which is (are) expressly incorporated by reference herein.

The present invention relates to a press having a feeding device for feeding the material to be machined, the feeding device having at least two motor-driven feeding rollers, between which the material to be fed is guided through.

Known presses with a feeding device have the disadvantage that the motor drive of the feeding rollers is housed in the close or more remote environment of the feeding rollers to be driven. Transmitting devices, such as transmission belts, chains, shafts, gear wheels or the like, therefore have to be provided in order to transmit the driving power of the motor drive to the feeding rollers. Another disadvantage is that these devices have play.

On one hand, such known transmitting devices are susceptible to disturbances and, on the other hand, they have to be provided with a certain installation space. Likewise, the motor drive requires an additional installation space. Furthermore, in the case of the previously known presses having a feeding device, the problem frequently occurs that the material fed into the tool is not optimally aligned in the tool, so that the parts produced by the pressing operation have a certain inaccuracy.

Known presses with a feeding device also have the disadvantage that, as a result of the vibrations of the press, the feeding device may swing, whereby the feeding device is severely strained and may result in failures of the feeding device.

### SUMMARY OF THE INVENTION

An object of the present invention is to provide a press of the aforementioned type such that the above-mentioned disadvantages will be avoided in the future.

The present invention has achieved this object with a press having a feeding device for feeding the material to be machined in which at least one or two motor-driven feeding rollers between which the material to be fed is guided through. According to the invention, the motor drive of the press feeding roller or rollers is housed in the feeding rollers, and at least one of the feeding rollers can be lifted off the material to be machined and can be placed against the material to be machined. The feeding device is on the press such that the feeding device has a degree of freedom in the vertical direction relative to the press. As a result of the fact that the motor drive of the feeding rollers will likely in the future be housed in the feeding rollers, a considerable amount of installation space can be saved which is therefore available to other components and, in the event of a repair, facilitates the accessibility to certain parts of the press.

Because of the ability to lift at least one of the feeding rollers off the material to be machined, the material to be machined can in the future be placed in an optimal machining position by stop pins which engage in prepared holes at the edge of the material to be machined. Waste can thereby be reduced in the future. Because of the degree of freedom in the vertical direction of the feeding device relative to the press, the feeding device will in the future no longer swing undesirably because of the vibrations of the press, so that the danger of an operating failure of the feeding device as a result of the machine vibrations transmitted to it will be eliminated.

Constructively, the combination of a feeding roller and a motor drive housed therein is particularly simple and not susceptible to disturbances if the motor drive of the feeding rollers is an electric external rotor motor. Then the external rotor of the motor will either be the roller body itself, or the external rotor is directly connected with the roller body. In this manner, additional transmitting devices are no longer required in order to transmit the driving power of the motor drive to the feeding rollers so that an operation is ensured which is as free of disturbances as possible.

When at least one of the feeding rollers is pressed by a prestressing device against the material to be machined, a slip-free feeding of the material with the motor-driven feeding rollers can be ensured. This slip-inhibiting effect of the prestressing device will be very useful particularly when the material to be machined can be wound off the coil only at a very high expenditure of force or an oil film covers the material to be machined or the feeding rollers.

At least one of the feeding rollers can be mounted on a roller rocking arm. The roller rocking arm is swivellable about a swivel bearing, so that the at least one feeding roller can be lifted off the material to be machined and can also be placed back onto the material to be machined.

For the purpose of better automation, the one or more liftable feeding rollers can be lifted off the material to be machined by the motor and can be placed against the material to be machined. For facilitating the mounting, an adapter can be provided between the feeding device and the press for mounting the feeding device on the press. Thus, in the event of a repair, the feeding device can be demounted relatively easily from the press and can then again be mounted on the press.

When the adapter has vertically extending oblong holes for receiving connection devices for connecting the feeding device with the press, the feeding device can move freely along these oblong holes, particularly for the height adjustment of the band inlet height. The transmission of vibrations of the press to the feeding device is reduced particularly by the spring system consisting of spiral springs and/or coil springs and/or cup springs, leaf springs, rubber springs.

### BRIEF DESCRIPTION OF THE DRAWINGS

Other objects, advantages and novel features of the present invention will become apparent from the following detailed description of the invention when considered in conjunction with the accompanying drawings.

FIGS. 1a and 1b are partial lateral and frontal views of a press and feeding device according to the present invention;

FIG. 2a is a detailed frontal view of the feeding device shown in FIGS. 1a and 1b;

FIG. 2b is a lateral view of the feeding device of FIG. 2a; and

FIG. 3 is a detailed view of the roller motor.

### DETAILED DESCRIPTION OF THE DRAWINGS

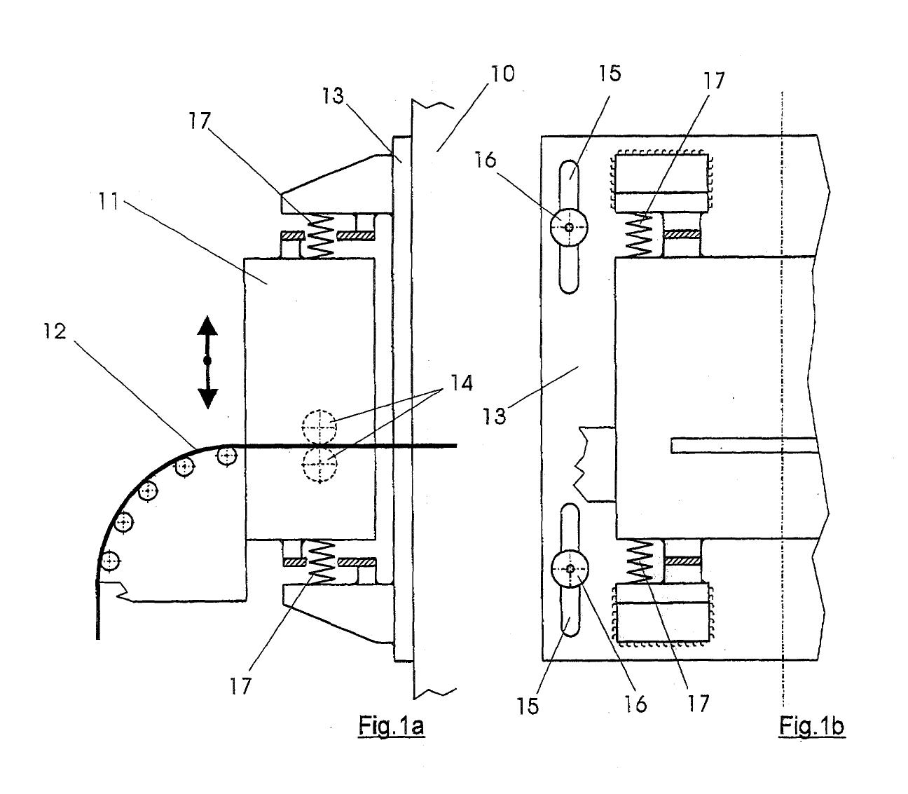

FIG. 1a shows a press 10 on which a feeding device 11 is arranged for feeding material 12 to be machined into a tool (not shown here in detail). The feeding device 11 is connected with the press 10 by an adapter 13. Feeding rollers 14 guide the material 12 to be machined to the tool of the press 10. For the at least partial uncoupling of vibrations of the press 10 acting in the vertical direction, the adapter 13 has oblong holes 15 for receiving fastening devices 16. As a result, the feeding device 11 and the press 10 can be moved relative to one another along the oblong holes 15 for the purpose of adapting the band inlet height. For reducing a swing of the feeding device 11, the latter has springs 17 and/or a spring/damper system 17 which reduce a swing of the feeding device 11. The feeding device 11 and the springs 17 therefore represent a spring—mass system which is uncoupled at least partially from the vertical vibrations of the press 10.

This is implemented particularly by a spring—damper system 17 which, as illustrated in FIG. 1a, operates such that movement of the feeding device 11 in the horizontal direction is avoided in order to prevent inaccuracies in the feeding direction while permitting movement in the vertical direction.

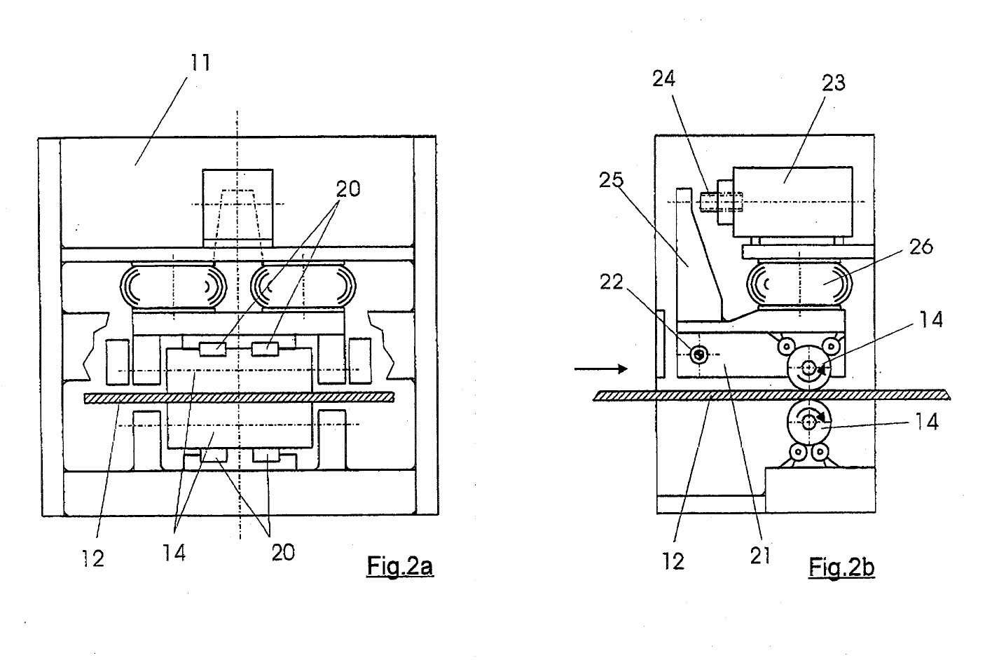

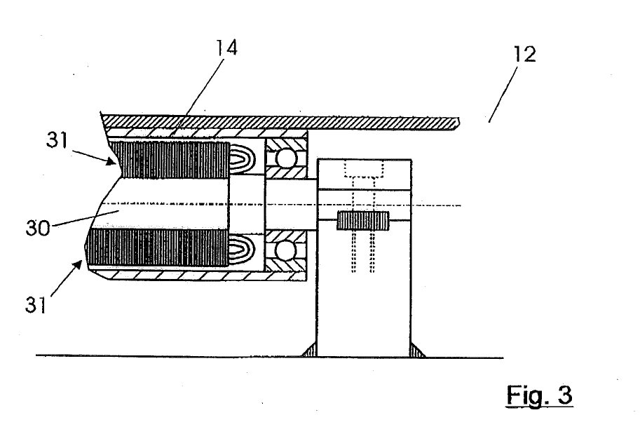

FIG. 2a illustrates the feeding device 11 with the feeding rollers 14 between and through which the material 12 is guided. A roller motor is housed in the rollers 14 which is preferably constructed as an external rotor motor (FIG. 3). This roller motor drives the rollers 14. In order to prevent a bending of the rollers with the motors arranged therein during the machining of narrow bands, roller supports 20 are provided below or above the rollers 14.

The upper roller 14 is arranged on a roller rocker arm 21 (see FIG. 2b). The roller rocker arm 21 is swivellably mounted on a swivel bearing 22. By way of a motor 23, which is currently preferably constructed as a hollow-shaft motor, a threaded spindle 24 is pressed against the upper leg 25 of the rocker arm 21, so that the roller 14 can lift off the material 12 to be machined. This lifting of the roller 14 off the material 12 to be machined may be necessary, for example, for a short time, in order to optimally position, by means of stop pins, the material 12 to be machined in the press tool, which is not shown here in detail. Furthermore, the lifting of the rollers 14 off the material 12 to be machined may also be required for threading the material 12 into the feeding device.

By way of the drive 23, the distance between the rollers 14 can also be adjusted in certain spacing steps corresponding to the respective thicknesses of the material 12 with a measurement of the band thickness. So that the rollers 14 transport the material in a manner which is as slip-free as possible, a prestressing device 26 presses the feeding rollers 14 with the material 12 guided between them against one another. The prestressing device 26 may preferably be constructed as a bellows-type cylinder with the scope of the present invention.

FIG. 3 is a detailed view of the roller motor 30 which drives the rollers 14 in order to be able to guide the material 12 to be machined through between the rollers 14. The roller motor 30 is constructed as an external rotor motor. An external rotor 31 is connected directly with the roller 14, so that no additional transmitting devices are required in order to transmit the engine power of the drive 30 to the roller 14, whereby this drive is permitted to operate in an extremely disturbance-free manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Press with a feeding device for feeding material to be machined, comprising at least two feeding rollers, with the feeding device having at least one motor-driven feeding roller such that the material to be fed is guided through the feeding rollers, wherein a motor drive of the at lest one motor-driven feeding rollers is housed in the associated feeding roller, at least one of the feeding rollers is arranged to be lifted off and placed against the material to be machined, and the feeding device is arranged on the press to have a degree of freedom in a vertical direction relative to the press.

2. Press according to claim 1, wherein the motor drive of the at least one motor-driven feeding roller is an electric external rotor motor.

3. Press according to claim 1, wherein at least one of the feeding rollers is arranged to be pressed by a prestressing device against the material to be machined.

4. Press according to claim 3, wherein the motor drive of the at least one motor-driven feeding roller is an electric external rotor motor.

5. Press according to claim 1, wherein at least one of the feeding rollers is mounted on a roller rocker arm.

6. Press according to claim 5, wherein the motor drive of the at least one motor-driven feeding roller is an electric external rotor motor.

7. Press according to claim 6, wherein at least one of the feeding rollers is arranged to be pressed by a prestressing device against the material to be machined.

8. Press according to claim 1, wherein a motor is provided to cause the at least one feeding roller to be lifted off and placed against the material to be machined.

9. Press according to claim 8, wherein the motor drive of the at least one motor-driven feeding roller is an electric external rotor motor.

10. Press according to claim 9, wherein at least one of the feeding rollers is arranged to be pressed by a prestressing device against the material to be machined.

11. Press according to claim 10, wherein at least one of the feeding rollers is mounted on a roller rocker arm.

12. Press according to claim 1, wherein a mounting adapter is arranged between the feeding device and the press.

13. Press according to claim 12, wherein the motor drive of the at least one motor-driven feeding roller is an electric external rotor motor.

14. Press according to claim 13, wherein at least one of the feeding rollers is arranged to be pressed by a prestressing device against the material to be machined.

15. Press according to claim 14, wherein at least one of the feeding rollers is mounted on a roller rocker arm.

16. Press according to claim 15, wherein a motor is provided to cause the at least one feeding roller to be lifted off and placed against the material to be machined.

17. Press according to claim 12, wherein the mounting adapter has vertically extending oblong holes for receiving connection devices.

18. Press according to claim 17, wherein at least one of the feeding rollers is mounted on a roller rocker arm.

19. Press according to claim 18, wherein a motor is provided to cause the at least one feeding roller to be lifted off and placed against the material to be machined.
